(19) United States
(12) Patent Application Publication
(10) Pub. No.: US 2017/0249669 A1
(43) Pub. Date: Aug. 31, 2017

(54) PROVIDING RELEVANT PRODUCT DEMONSTRATIONS

(71) Applicant: Wal-Mart Stores, Inc., Bentonville, AR (US)

(72) Inventors: Donald High, Noel, MO (US); Michael Atchley, Springdale, AR (US); Eric Welch, Bentonville, AR (US)

(21) Appl. No.: 15/329,862

(22) PCT Filed: Jul. 29, 2015
(86) PCT No.: PCT/US2015/042622

§ 371 Date: Jan. 27, 2017

Related U.S. Application Data
(60) Provisional application No. 62/030,328, filed on Jul. 29, 2014.

(51) Int. Cl. G06Q 30/02

(52) U.S. Cl. CPC G06Q 30/0269; G06Q 30/0261; G06Q 30/0264

(57) ABSTRACT

A system receives registrations of users specifying a geographic preference and product preferences for demonstrations. The system likewise receives notifications of available demonstrations from vendors. Relevant demonstrations are identified for each user. In response to detecting a demonstration meeting the user's geographic preference, a notification of the demonstration is transmitted to the user. Notifications may be sent in response to demonstrations within a threshold distance from a location specified by the user, upon the user entering a store near a scheduled time for a relevant demonstration. Notifications may be sent in response to detecting a relevant demonstration within a threshold time from a predicted shopping trip of the user.

### RELATED APPLICATIONS

This application claims the benefit of U.S. Provisional Ser. No. 62/030,328, filed Jul. 29, 2014 and entitled System and Method for Publicizing Product Promotion Events.

### BACKGROUND

Field of the Invention

This invention relates to systems and methods for providing in-store demonstrations to customers.

Background of the Invention

Product promotion events at retail stores are a common occurrence. These events typically involve demonstrations or providing samples to customer at the retail location. Typically, a product supplier to the retail store will arrange to provide the demonstration or samples on-site. These may be scheduled so that a variety of demonstrations are available at the same time so customers can be exposed to a number of demonstrations at peak shopping times.

The success of these promotions depends on the participation of customers most likely to purchase the products. However, with multiple retail locations in close proximity, each hosting several promotions, it may be unlikely that a particular customer will pass by and interact with a product promotion of high relevance to that customer.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIG. 3 is a process flow diagram of a method for selecting demonstrations in accordance with an embodiment of the present invention; and

FIG. 4 is a process flow diagram of a method for providing notifications of demonstrations in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

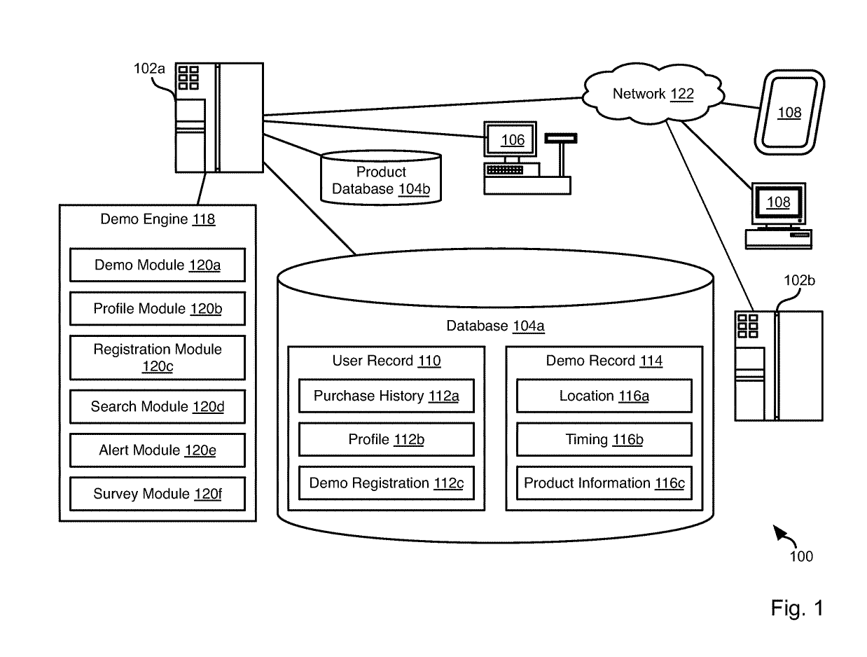

Referring to FIG. 1, a network environment 100 may be used to implement methods as described herein. The environment 100 may include a server system 102a associated with a corporate parent or controlling entity having one or more retail establishments associated therewith. The server system 102a may host or access a database 104a of user and demonstration data. The server system 102a may further host or access a product database 104b. The retail establishments may house point of sale devices (POS) 106 on which transactions may be concluded. The POS 106 may also be part of an e-commerce system. The e-commerce system may include, for example, a web-application that permits customers to purchase various products and/or services over the Internet. POSs 106 in communication with the server system 102a may include POSs 106 associated with a warehouse store that is a separate entity or format than the retail establishments.

Online POSs 106 may interact with remote user computers 108. In particular, server system 102a may host a website that may be browsed by users on the user computers 108 and through which the users may invoke purchase and shipment of products in a product database 104b. The remote user computers 108 may be embodied as laptop or desktop computers, mobile phones, tablet computers, wearable computers, or other computing device.

Records of transactions may be transmitted to the server system 102a by the POSs 106 at one or more outlets, e.g. retail establishments, warehouse stores, and ecommerce systems. The records of various transactions from the various outlets may be associated to individual customers. Specifically, unique data such as a credit card number, address, username, membership number, and the like may be associated with a particular customer. Accordingly, transaction records including one or more items of this unique data may be associated with that user. For example, transaction records determined to be associated with a particular user may be stored in a user record 110 for that user in the database 104a, such as in a purchase history 112a of the user record 110.

The user record 110 for that user may further include records of other information received from a user or gathered from observation of user actions. For example, the user record 110, may include a profile 112b of the interests of the user either self-reported or inferred from user activates. The user record 110 may further include a demonstration registration 112c record, which is described in greater detail below.

The database 104a may further include one or more demonstration records 114 describing demonstrations scheduled to be performed at one or more of the retail establishments. The demonstration records 114 may be received from other computer systems, such as a server system 102b operated by a vendor or other third party that is performing the demonstration, supplying a product or service demonstrated, or on whose behalf a demonstration is being performed.

A demonstration record 114 may include location information 116a indicating a location the demonstration is to be performed, timing information 116b indicating a date and time of a demonstration, and product information 116c identifying the product being demonstrated and possibly including a listing of attributes of the product and/or demographic information of customers targeted by the product. The demonstration record 114 may be for a series of demonstrations, in which case the location 116a may indicate a set of locations and the timing 116b information may indicate a series of times each corresponding to a location where a demonstration is to be performed. The location 116a may simply list an address of the retail location where the demonstration is to be performed or may also indicate a specific location in the store for the demonstration (e.g. a department, GPS coordinates, aisle number, or the like).

The server system 102a may execute a demonstration engine 118. The demonstration engine 118 may include a demonstration module 120a that receives some or all of the information of a demonstration record 114 from a server system 102b of a vendor wishing to conduct a demonstration. In response to receiving this information, the demonstration module 120a may create a demonstration record 114 populated with this information.

For example, a vendor associated with the server system 102b, in cooperation with retailer employees associated with the server system 102a, may schedule one or more product promotion events. As part of this process various event attributes may be recorded in a database, such as in the demonstration record 114. Event attributes may include product type information, product price information, supplier information, event start time, event end time, and event location. The event attributes may be associated with a unique event identifier in an event database, e.g. in a demonstration record 114 having the unique event identifier and storing the event attributes.

The demonstration engine 118 may further include a profile module 120b. The profile module 120b may analyze customer transaction data, survey responses, and information provided by the customer and populate a profile of the customer. The demonstration engine 118 may include a registration module 120c that receives requests to register for demonstrations by a customer and receives parameters for selecting demonstrations of interest to the customer.

For example, a customer may, using a retailer website hosted by server system 102a and/or a mobile application executing on a user computer 108, register with the registration module 120c and register to receive alerts from an alert module 120e and opt in to receiving notifications. The customer may be associated with a unique customer identifier, such as a unique identifier associated with a user record 110 for the customer. The profile module 120b may collect a variety of customer attributes and store them in the user record 110 of the customer. The customer attributes may include customer name, address or home zip code, product preferences, hobbies, historical spending data that may include amounts spent, store location, and products purchased. Additional customer attributes may be collected or estimated including customer age, household income, favorite brands, frequent locations, hobbies and interests, typical shopping days and times, etc. The customer may select favorite products that are stored in a favorites list by scanning a UPC or other code on a product, or by searching a product database 104b. The customer can also delete items after they are added.

The demonstration engine 118 may include a search module 120d. For example, upon registration, the search module 120d may provide an interface to search the product promotion database. Searches may be conducted by using a number of parameters such as product or brand name, product features, price, location, time, or other promotion attributes. Search results may be ranked in relevance based on the search terms used, based on the customer attributes (so as to list the promotions believed most likely to be of interest to the customer), chronologically, based on proximity to the customer's current location, or based on proximity to the customer's home address/zip code as recorded in the user record 110 of the customer. The system may record search histories, and promotions viewed from the search results to refine the estimation of the customer's interests. Search results may be limited to those scheduled in the next week or other default time period, which could be adjusted by the customer.

Customer searches may also be done by retail location. For example, if a customer has decided to make a shopping trip, they may select a retail location from a list or map of nearby locations to view then current or scheduled promotions for that location. The customer can then choose which location to visit based on the promotions offered.

As a part of the registration process, the registration module 120c may invoke transmission of questions to determine some of the customer's interests for selecting promotion notifications to send the customer. The registration module 120c may receive inputs from a customer in response to these questions and store them as part of the demonstration registration 112c of the user record for that customer. The registration module 120c may further receive user inputs that invoke setting or adjusting of certain settings including a range within which the customer may be interested in participating in a promotion. That range may be set at a default, such as 50 miles, as measured from the customer's home or current location. Customers may also change their default location from their home to another location. For example, a customer may be in the habit of shopping after work, so that customer may select their work location as their default location. The customer may select a default retail location that is the location they most commonly visit. The range or other location information as received from the customer may be stored in the user record 110 of the user, such as in the demonstration registration 112c of the customer.

After registration and collection of at least some customer information, the alert module 120e may provide notifications of potentially relevant promotions to the customer. Notifications may be provided by email, text message, in-app notifications, and/or push notifications. The notifications may include a survey feature to collect a customer response to the notification. The survey may be as simple as a single question such as “did you find this notification useful?” or a more detailed survey with multiple questions may be provided. Customer responses to these surveys may be provided to a survey module 120f, which further refines the process of selecting which promotions to notify the customer of.

The alert module 120e may send one or more product promotion notifications to a customer based on the customer and promotion attributes. In addition, notifications may be timed to maximize their impact. For example, notifications may be sent within 24 hours of a customer's average weekly shopping time highlighting promotions to be held within the next few days at the customer's usual retail location. Additionally, a notification of promotions currently underway or starting soon may be sent when a customer's device location service indicates that the customer is entering or near a retail location.

Notifications can take a variety of forms. For example, a push notification to a user device may be tapped to open the notification in the mobile application. The mobile application may include directions to the retail location and a store map showing where in the store the product promotion is to be held. Promotion notifications may also include links to a retail website or shopping application for the customer to purchase the promoted product remotely and arrange for pick-up or delivery.

The mobile application may be used to provide alerts to the customer for items on the customer's favorite list. Additionally, when a customer develops an interest in a product, they can use the application search function to select the product for an alert list without adding it to their favorites. Alerts may be treated differently than other notifications and provided with a series of customizable settings that may include the frequency alerts are sent, how far in advance of a promotion are alerts sent, a larger or smaller range in which the customer would be willing to travel for a promotions, etc.

A survey may be provided to the customer to determine if they participated in the promotion and how relevant it was to the customer. The results of the survey may be used to refine the selection of which promotions to provide the user and similar users. Additionally, a sign at the promotion location may include one or more codes (such as bar codes, QR codes, and the like), which may be scanned using the customer device while using the mobile application. Scanning the code may send a “liked it” or “didn't like it” message that could be used for purposes of surveying. The mobile application or website may also allow the user to publish their reaction to a promotion on social media. Additional products may also be recommended based on a customer response and could include related products meant to be used with the promoted product or sold by the same brand.

The server system 102a may be in data communication with the server system 102a, POSs 106, and user computers 108 by means of a network 122. The network 122 may include any wired or wireless connections and may include some or all of a local area network (LAN), wide area network (WAN), the Internet, or other type of network.

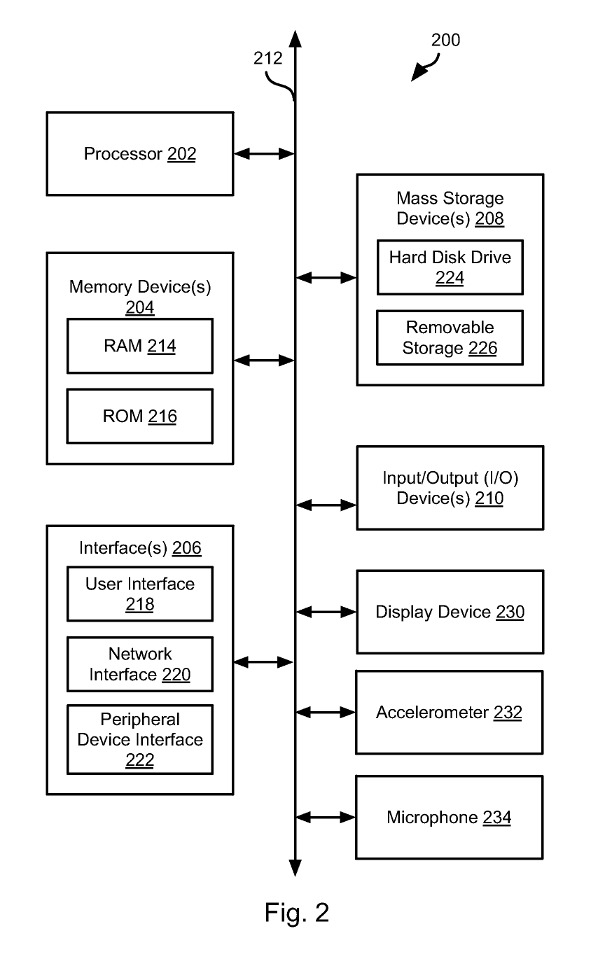

FIG. 2 is a block diagram illustrating an example computing device 200. Computing device 200 may be used to perform various procedures, such as those discussed herein. The server systems 102a, 102b, POSs 106, and user computers 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102a may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

A computing device 200 implementing the user computers 108 may advantageously include one or more sensors. The output of these sensors may be used to determine whether a media file is viewed solely for inspiration or viewed during execution of a meal that the media file instructs how to prepare. In some embodiments, the sensors include an accelerometer 232 that detects acceleration of the user computer 108 in which it is included as well as the orientation thereof. In some embodiments, the sensors further include a microphone 234 capable of detecting sounds incident on the user computer 108.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

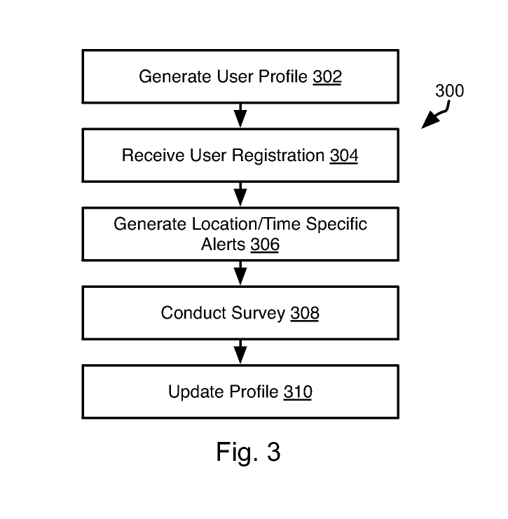

Turning now to FIG. 3, the illustrated method 300 may be executed by the server system 102a with respect to each user record 110 of a plurality of user records, the user record representing a specific customer, family, or other entity, hereinafter “the user.” Actions performed with respect to the user may be interpreted as being performed with respect to a user computing device 108 of the user. In particular, the method 300 may be executed by the demonstration engine 118 described above.

The method 300 may include generating 302 a user profile. Generating a profile may include analyzing a purchase history 112a of the user. In particular, items purchased may be related to types of food, types of activities, or attributes of products that are of interest to the user. Generating a profile may include obtaining responses to survey questions form the user that indicate demographics (age, gender, income), geographic location, interests, hobbies, and the like. Likewise, generating 302 a user profile may include recording responses of the user to demonstrations for which notifications have been sent according to the methods disclosed herein as described above with respect to the survey module 120f.

The method 300 may further include receiving 304 a user registration. As noted above, registering a user may be performed by the registration module 120c. Receiving 304 a user registration may include receiving user preferences for types of products that customer would like to see demonstrated as well as other attributes of the customer such as demographic information, interests, products regularly purchased, and the like. Receiving 304 a registration may further include receiving geographic information. For example, may request notifications of demonstrations occurring within a specific region. The region may be specified as a location (e.g. a user's residence, place of work, or preferred retail location) and a distance from that location. Geographic information may include an instruction to notify the user of demonstrations within a given radius from the user's current location, e.g. a location of a user computing device 108 including a GPS receiver.

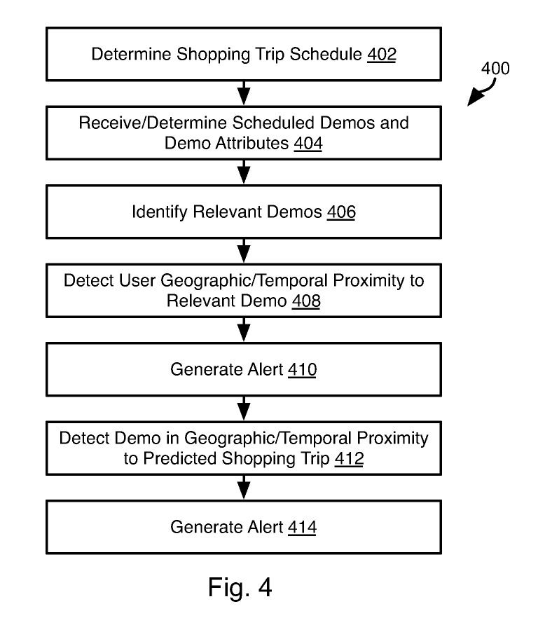

The method 300 may further include generating 306 location and time specific alerts. In particular, the server system 102a may transmit notifications of demonstrations that are scheduled to be performed within the regions specified in the registration step 304 and within some threshold number of hours or days from the current date and time. An example method for providing location and time specific alerts is described below with respect to FIG. 4. Generating 306 location and time specific alerts may be performed by the alert module 120e and may include performing some or all of the functions ascribed to the alert module 120e.

The method 300 may further include conducting 308 a survey to the user and updating 310 the user profile according to the survey. For example, questions may be transmitted to the user and responses to the questions may be received by the server system 102a and used to update 310 the profile 112b of the user. For example, step 308 may include asking whether the user actually attended the demo, liked the demonstration, purchased a demonstrated product, is interested in similar demonstration or the like.

Referring to FIG. 4, the illustrated method 400 may be executed by the server system 102a with respect to each user record 110 of a plurality of user records, the user record representing a specific customer, family, or other entity, hereinafter “the user.” Actions performed with respect to the user may be interpreted as being performed with respect to a user computing device 108 of the user. In particular, the method 400 may be executed by the demonstration engine 118 described above.

The method 400 may include analyzing the user's purchase history 112a and determining 402 a shopping trip schedule. In particular, the days of the week on which purchases occur may be analyzed to determine one or both of the most common day or days of the week on which purchases occur and the number of days between shopping trips. Accordingly, using this information, the date of the user's next shopping strip may be determined to be that day of the week or that number of days after the most recent shopping trip.

The method 400 may further include receiving 404 or determining scheduled demonstrations and demonstration attributes. This may include receiving or analyzing demonstration records 114 created in cooperation with a third party server system 102b or otherwise received from a third party vendor.

The demonstrations may be evaluated to identify 406 demonstrations that are relevant to the user. For example, keyword similarity between a product description for a demonstration and keywords in the profile 112b and or demonstration registration 112c of the user may be compared. Those demonstrations having an above-threshold similarity or the top N most similar demonstrations according to a similarity metric may be identified 406 as relevant to the user. The similarity metric may include any similarity metric known in the art to determine similarity between a set of words or documents.

The method 400 may further include detecting 408 geographic and/or temporal proximity of the user (e.g. the user's GPS-equipped computing device 108) to a relevant demonstration. For example, if the user device is within X miles of a demonstration to be performed within the next Y minutes, where X and Y are predetermined threshold values, then an alert may be generated 410 that notifies the user of the demonstration and includes relevant details, such as the address, in-store location, time, product to be demonstrated in the demonstration, and/or other information included in the demonstration record 114 for the demonstration. The values of X and Y may be default values or specified as part of the user's demonstration registration 112c.

In some embodiments, a notification may be generated 410 some predetermined time period prior to the start time of demonstrations that are within Y miles of the users residence or other location specified for the user in the user's demonstration registration 112c, where Y is a distance from the specified location that is also specified in the user's demonstration registration 112c.

In some embodiments, a notification may be generated 410 in response to detecting arrival of the user at a retail location of a demonstration identified 406 as relevant within a window from Z minutes before the start time and another point in time some time prior to the end time of the demonstration, where Z is a predetermined time value.

In some embodiments, the method 400 may include detecting 412 relevant demonstrations that are scheduled to occur within a threshold geographic proximity to the location specified in the user's demonstration registration 112c and within a threshold temporal proximity to the expected time of the user's next shopping trip as determined at step 402. In response to detecting that the expected date of a shopping trip is within the threshold temporal proximity to a demonstration within the threshold proximity from the user-specified location, the method may include generating 414 an alert notifying the user of the demonstration, including relevant details describing the demonstration such as the address, in-store location, time, product to be demonstrated in the demonstration, and/or other information included in the demonstration record 114 for the demonstration.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A system comprising:
a database storing (a) a customer profile for each customer of a plurality of customers, the customer profile for the each customer including a geographic preference and demonstration preferences of the customer and (b) a plurality of demonstration records each including a location, time, and description of a demonstration; and
a server system comprising one or more processors and one or more memory devices operably coupled to the one or more processors, the one or more memory devices storing executable and operational code effective to execute a demonstration engine effective to, for each customer profile, (i) identify at least one demonstration record having a location corresponding to the geographic preference of the user and (ii) transmit to the customer corresponding to the each customer profile a notification of the at least one demonstration record.

2. The system of claim 1, wherein the demonstration engine is further effective to identify the at least one demonstration record having the location corresponding to the geographic preference of the user by identifying as the at least one demonstration record a portion of the plurality of demonstration records having a location within a threshold distance from a user-specified location included in the each customer profile.

3. The system of claim 1, wherein:
the customer profile of the each customer further includes a purchase history of the user;
the demonstration engine is further effective to (iii) evaluate dates of transactions included in the purchase history of the user and determine an expected future shopping date according to a frequency of the transactions, (iv) identify the at least one demonstration record as having both of the time thereof within a threshold temporal proximity to the expected future shopping date and the location thereof satisfying the geographic preference of the user.

4. The system of claim 1, wherein:
the customer profile further includes a product preference of the user; and
the demonstration engine is further effective to identify the at least one demonstration record as having both the location corresponding to the geographic preference of the user and the description of the at least one demonstration record corresponding to the product preference of the user.

5. The system of claim 1, wherein the demonstration engine is further effective to identify the at least one demonstration record as having the location corresponding to the geographic preference of the user in response to detecting the user arriving at a retail location corresponding to the at least one demonstration record within a time window including the time of the at least one demonstration.

6. The system of claim 1, wherein:
the customer profile further includes a product preference of the user; and
the demonstration engine is further effective to identify the at least one demonstration record as having the location corresponding to the geographic preference of the user if both of (a) the description of the at least one demonstration record corresponds to the product preference of the user and (b) the user arrives at a retail location corresponding to the at least one demonstration within a time window including a time of the at least one demonstration.

7. The system of claim 1, wherein the demonstration engine is effective to transmit to the customer corresponding to the each customer profile the notification of the at least one demonstration record by sending an electronic message to an electronic device of the each customer.

8. The system of claim 7, wherein the electronic device is a mobile phone.

9. The system of claim 1, wherein the demonstration engine is further effective to create the each customer profile in response to registration of the customer corresponding to the each customer profile.

10. The system of claim 1, wherein the demonstration engine is further effective to:
transmit a survey regarding the at least one demonstration to the each customer;
receive a response from the each customer; and
update the customer profile for the each customer according to the response.

11. A method comprising:
providing a database storing (a) a customer profile for each customer of a plurality of customers, the customer profile for the each customer including a geographic preference and demonstration preferences of the customer and (b) a plurality of demonstration records each including a location, time, and description of a demonstration;
performing by a server system comprising one or more processors and one or more memory devices operably coupled to the one or more processors—
identifying at least one demonstration record having a location corresponding to the geographic preference of the user; and
transmitting to the customer corresponding to the each customer profile a notification of the at least one demonstration record.

12. The method of claim 1, wherein identifying the at least one demonstration record having the location corresponding to the geographic preference of the user further comprises identifying as the at least one demonstration record a portion of the plurality of demonstration records having a location within a threshold distance from a user-specified location included in the each customer profile.

13. The method of claim 11, wherein:
the customer profile of the each customer further includes a purchase history of the user;
the method further comprises—
evaluating dates of transactions included in the purchase history of the user and determining an expected future shopping date according to a frequency of the transactions; and
identifying the at least one demonstration record as having both of the time thereof within a threshold temporal proximity to the expected future shopping date and the location thereof satisfying the geographic preference of the user.

14. The method of claim 11, wherein:
the customer profile further includes a product preference of the user; and
the method further comprises identifying the at least one demonstration record as having both the location corresponding to the geographic preference of the user and the description of the at least one demonstration record corresponding to the product preference of the user.

15. The method of claim 11, further comprising identifying the at least one demonstration record as having the location corresponding to the geographic preference of the user in response to detecting the user arriving at a retail location corresponding to the at least one demonstration record within a time window including the time of the at least one demonstration.

16. The method of claim 11, wherein:
the customer profile further includes a product preference of the user; and
the method further comprises identifying the at least one demonstration record as having the location corresponding to the geographic preference of the user if both of (a) the description of the at least one demonstration record corresponds to the product preference of the user and the user arrives at a retail location corresponding to the at least one demonstration within a time window including a time of the at least one demonstration.

17. The method of claim 11, further comprising transmitting to the customer corresponding to the each customer profile the notification of the at least one demonstration record by sending an electronic message to an electronic device of the each customer.

18. The method of claim 17, wherein the electronic device is a mobile phone.

19. The method of claim 11, further comprising creating the each customer profile in response to registration of the customer corresponding to the each customer profile.

20. The method of claim 11, further comprising:
transmitting a survey regarding the at least one demonstration to the each customer;
receiving a response from the each customer; and
updating the customer profile for the each customer according to the response.
